(19) United States
(12) Patent Application Publication
(10) Pub. No.: US 2011/0221787 A1
(43) Pub. Date: Sep. 15, 2011

(54) METHOD OF DRIVING DISPLAY PANEL AND DISPLAY APPARATUS FOR PERFORMING THE SAME

(75) Inventors: Uk-Chul CHOI, Cheonan-si (KR); Cheol-Woo PARK, Suwon-si (KR)

(73) Assignee: SAMSUNG ELECTRONICS CO., LTD., Suwon-si (KR)

(21) Appl. No.: 13/009,915

(22) Filed: Jan. 20, 2011

(30) Foreign Application Priority Data
Mar. 11, 2010 (KR) 2010-0021853

(51) Int. Cl. G09G 5/10; G09G 3/36

(52) U.S. Cl. 345/690; 345/87

(57) ABSTRACT

A method of driving a display panel, the display panel comprising a plurality of color pixels, each of the color pixels comprising a cholesteric liquid crystal layer, the method including; generating a plurality of color sub-data from color data using a spatial division grayscale algorithm and converting the color sub-data into a data voltages to be provided to the color pixels

This application claims priority to Korean Patent Application No. 2010-21853, filed on Mar. 11, 2010, and all the benefits accruing therefrom under 35 U.S.C. §119, the content of which in its entirety is herein incorporated by reference.

### BACKGROUND OF THE INVENTION

1. Field of the Invention

Exemplary embodiments of the present invention relate to a method of driving a display panel and a display apparatus for performing the method. More particularly, exemplary embodiments of the present invention relate to a method of driving a display panel having cholesteric liquid crystal molecules and a display apparatus for performing the method.

2. Description of the Related Art

Generally, although molecules of a liquid crystal layer are regularly arranged, the liquid crystal has a fluidity similar to that of a liquid. The liquid crystal generally flows like the liquid, but the liquid crystal has different optical characteristics according to a direction of orientation thereof, similar to that of a crystal.

The typical liquid crystal material has long and narrow molecules with a rod-like shape. An arrangement of the molecules is changed or a motion of the molecules may be scattered by an external electric field, a magnetic field, heat, etc. Therefore, the optical characteristics of the liquid crystal may be easily changed and manipulated.

The liquid crystal material may be classified into different types of liquid crystal such as a nematic liquid crystal or a cholesteric liquid crystal according to an arrangement of molecules within the liquid crystal material. The arrangement, e.g., positioning, of the molecules in the nematic liquid crystal is irregular, but a molecular axis of the nematic liquid crystals is commonly oriented in a particular direction. A direction of an axis alignment of molecules arranged in an upper portion of the liquid crystal is substantially the same as that in a lower portion of the liquid crystal so that a polarization is offset in both directions. Thus, the nematic liquid crystal does not have ferroelectric characteristics. The cholesteric liquid crystal has a layered structure having a plurality of layers, and an arrangement of molecules in each of the individual layers is similar to the arrangement of the nematic liquid crystal. For example, positional relationships of liquid crystal molecules within a single layer are irregular, but an axis alignment of the molecules is substantially the same within each of the layers. Each of the layers is typically very thin. The arrangement of the molecules in each layer is directed along a longitudinal axis thereof, and surfaces of the layers are substantially parallel with each other. A longitudinal axis of each of the layers is slightly offset from a longitudinal axis of an adjacent layer, so that an overall arrangement of the molecules in the cholesteric liquid crystal is a spiral structure.

FIGS. 1A, 1B and 1C are conceptual diagrams illustrating an alignment change of cholesteric liquid crystal molecules according to an intensity of an electric field applied thereto.

Referring to FIG. 1A, when an electric field E applied to the cholesteric liquid crystal is greater than a first electric field E_{C}, the cholesteric liquid crystal is arranged in a homeotropic alignment. Referring to FIG. 1B, when the electric field E is rapidly decreased to be smaller than a second electric field E_{F} in the homeotropic alignment, the cholesteric liquid crystal is arranged in a planar alignment. Referring to FIG. 1C, when the electric field E is greater than the first electric field E_{C} and less than the second electric field E_{F} in the homeotropic alignment, the cholesteric liquid crystal is arranged in a focal conic alignment. The cholesteric liquid crystal in the planar alignment reflects light having a specific wavelength, and the cholesteric liquid crystal in the focal conic alignment scatters the light.

A reflective display apparatus using the above-mentioned driving characteristics of the cholesteric liquid crystal has been developed, but the cholesteric liquid crystal has a relatively slower transition period, e.g., a transition from a reflecting state to a scattering state, with respect to the electrical field applied thereto. Applying a greater voltage differential to the cholesteric liquid crystal may increase a driving speed and decrease a transition period. Therefore, a new driving chip suitable for a high voltage driving is required.

### BRIEF SUMMARY OF THE INVENTION

Exemplary embodiments of the present invention provide a method of driving a display panel having a cholesteric liquid crystal.

Exemplary embodiments of the present invention also provide a display apparatus for performing the above-mentioned method.

In an exemplary embodiment of a method of driving a display panel according to the present invention, the display panel includes a plurality of color pixels. Each of the plurality of color pixels includes cholesteric liquid crystal layers. A plurality of color sub-data is generated from color data using a spatial division grayscale algorithm. The color sub-data are converted into a data voltage to be provided to the color pixel.

In an exemplary embodiment, the data voltage may include a reference voltage which drives the cholesteric liquid crystal layer to have a homeotropic alignment and a color voltage which drives the cholesteric liquid crystal layer to have a planar alignment.

In an exemplary embodiment, the data voltage may be inverted with respect to the reference voltage on a frame by frame manner to be provided to the color pixel.

In an exemplary embodiment, the color pixel may include a first sub-area and a second sub-area which is larger than the first sub-area.

In an exemplary embodiment, in the step of generating the color sub-data, first and second color sub-data to display black in the first and second sub-areas of the color pixel may be generated when the color data are within a first grayscale range. The first and second color sub-data to display a color in the first sub-area of the color pixel and to display black in the second sub-area of the color pixel may be generated when the color data are within a second grayscale range. The first and second color sub-data to display black in the first sub-area of the color pixel and to display a color in the second sub-area of the color pixel may be generated when the color data are within a third grayscale range. The first and second color sub-data to display a color in the first and second sub-area of the color pixel may be generated when the color data are within a fourth grayscale range. In one exemplary embodiment the first-fourth grayscale ranges may be different.

In an exemplary embodiment, in the step of converting the color sub-data into the data voltage, the first color sub-data may be converted into a first data voltage to be provided to the color pixel during a first interval of a horizontal period, and the second color sub-data may be converted into a second data voltage to be provided to the color pixel during a second interval of the horizontal period.

In an exemplary embodiment, in the step of converting the color sub-data into the data voltage, the first and second color sub-data may be converted into the data voltages to be provided to the color pixel at substantially the same time during a horizontal period.

In an exemplary embodiment, the color pixels may include a red pixel, a green pixel and a blue pixel. A first sub-area of the green pixel may be adjacent to second sub-areas of the red and blue pixels. A second sub-area of the green pixel may be adjacent to first sub-areas of the red and blue pixels.

In an exemplary embodiment, the color voltage may include red, green and blue color voltages. The red color voltage may drive the cholesteric liquid crystal layer to have the red pixel in a planar alignment and may have a first voltage level difference with respect to the reference voltage. The green color voltage may drive the cholesteric liquid crystal layer of the green pixel to have a planar alignment and may have a second voltage level difference with respect to the reference voltage. The blue color voltage may drive the cholesteric liquid crystal layer of the blue pixel to have a planar alignment and may have a third voltage level difference with respect to the reference voltage.

In an exemplary embodiment of a display apparatus according to the present invention, the display apparatus includes a display panel and a panel driver. The display panel includes a plurality of color pixels. Each of the plurality of color pixels includes a cholesteric liquid crystal layer. The panel driver generates a plurality of color sub-data from color data using a spatial division grayscale algorithm. The panel driver converts the color sub-data into a data voltage to be provided to the color pixel.

In an exemplary embodiment, the display panel may have a plurality of cell gaps which differ from each other according to colors of the color pixels.

In an exemplary embodiment, the panel driver may generate a reference voltage which drives the cholesteric liquid crystal layer to have a homeotropic alignment and a color voltage which drives the cholesteric liquid crystal layer to have a planar alignment.

In an exemplary embodiment, the panel driver may invert the data voltage with respect to the reference voltage on a frame by frame manner to provide the inverted data voltage to the color pixel.

In an exemplary embodiment, the color pixel may include a first sub-area and a second sub-area which is larger than the first sub-area. The panel driver may generate first and second color sub-data to display black in the first and second sub-areas of the color pixel when the color data are within a first grayscale range, the first and second color sub-data to display a color in the first sub-area of the color pixel and to display black in the second sub-area of the color pixel when the color data are within a second grayscale range, the first and second color sub-data to display black in the first sub-area of the color pixel and to display a color in the second sub-area of the color pixel when the color data are within a third grayscale range, and the first and second color sub-data to display a color in the first and second sub-areas of the color pixel when the color data are within a fourth grayscale range. Wherein in one exemplary embodiment the first through fourth grayscale ranges are different.

In an exemplary embodiment, the color pixel may include first and second sub-electrodes. The first sub-electrode may be electrically connected to a data line and a first gate line. The first sub-electrode may be disposed in the first sub-area. The second sub-electrode may be electrically connected to the data line and a second gate line. The second sub-electrode may be disposed in the second sub-area.

In an exemplary embodiment, the panel driver may output a first gate signal having a high voltage level to the first gate line and a first data voltage corresponding to the first color sub-data to the data line during a first interval of a horizontal period, and a second gate signal having a high voltage level to the second gate line and a second data voltage corresponding to the second color sub-data to the data line during a second interval of the horizontal period, wherein the high voltage level is sufficient to turn on a transistor connected to the data line.

In an exemplary embodiment, the color pixel may include first and second sub-electrodes. The first sub-electrode may be electrically connected to a first data line and a gate line. The first sub-electrode may be disposed in the first sub-area. The second sub-electrode may be electrically connected to a second data line and the gate line. The second sub-electrode may be disposed in the second sub-area.

In an example embodiment, the panel driver may output a gate signal having a high voltage level to the gate line and may respectively output the data voltages corresponding to the first and second color sub-data to the first and second data lines, during the horizontal period.

In an example embodiment, the color pixels may include a red pixel, a green pixel and a blue pixel. The first sub-area of the green pixel may be adjacent to the second sub-areas of the red and blue pixels, and the second sub-area of the green pixel may be adjacent to the first sub-areas of the red and blue pixels.

In an exemplary embodiment, the color voltage may include red, green and blue color voltages. The red color voltage may drive the cholesteric liquid crystal layer of the red pixel to have a planar alignment and may have a first voltage level difference with respect to the reference voltage. The green color voltage may drive the cholesteric liquid crystal layer of the green pixel to have a planar alignment and may have a second voltage level difference with respect to the reference voltage. The blue color voltage may drive the cholesteric liquid crystal layer of the blue pixel to have a planar alignment and may have a third voltage level difference with respect to the reference voltage.

According to the preset invention, a display panel including a first color pixel including a cholesteric liquid crystal having a first pitch, a second color pixel including a cholesteric liquid crystal having a second pitch, and a third color pixel including a cholesteric liquid crystal having a third pitch is driven to display a color image.

### BRIEF DESCRIPTION OF THE DRAWINGS

The above and other features and advantages of the present invention will become more apparent by describing in detailed example embodiments thereof with reference to the accompanying drawings, in which:

FIGS. 1A, 1B and 1C are conceptual diagrams illustrating an alignment change of cholesteric liquid crystal according to an intensity of an electric field applied thereto;

FIG. 2 is a block diagram illustrating an exemplary embodiment of a display apparatus according to the present invention;

FIG. 3 is a cross-sectional view illustrating a portion of an exemplary embodiment of a display panel of FIG. 2;

FIG. 4 is an equivalent circuit diagram illustrating the exemplary embodiment of a display panel of FIG. 2;

FIG. 5 is a block diagram illustrating an exemplary embodiment of a main driving circuit of FIG. 2;

FIG. 6 is a conceptual diagram illustrating an exemplary embodiment of a space division grayscale algorithm according to a timing controller of FIG. 5;

FIG. 7 is a flow chart illustrating an exemplary embodiment of a method of driving the main driving circuit of FIG. 5;

FIG. 8 is a timing diagram illustrating an exemplary embodiment of a method of driving the display panel of FIG. 2;

FIG. 9 is an equivalent circuit diagram illustrating another exemplary embodiment of a display panel according to the present invention;

FIG. 10 is a timing diagram illustrating an exemplary embodiment of a method of driving the exemplary embodiment of a display panel of FIG. 9; and

FIG. 11 is a cross-sectional view illustrating a portion of another exemplary embodiment of a display panel according to the present invention.

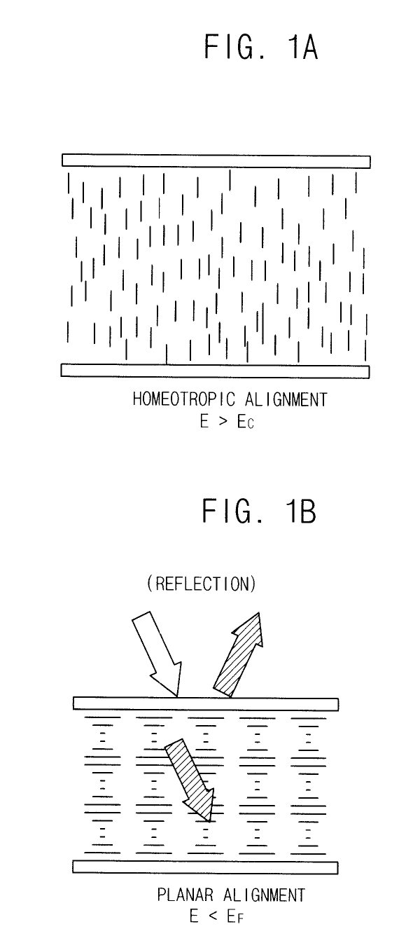

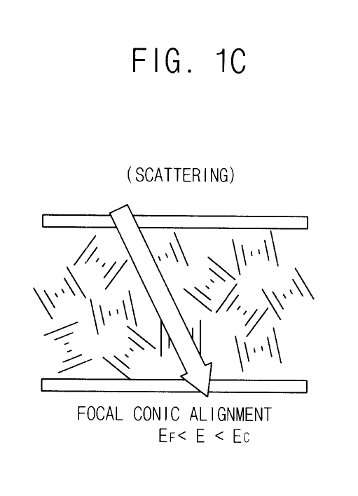

### DETAILED DESCRIPTION OF THE INVENTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

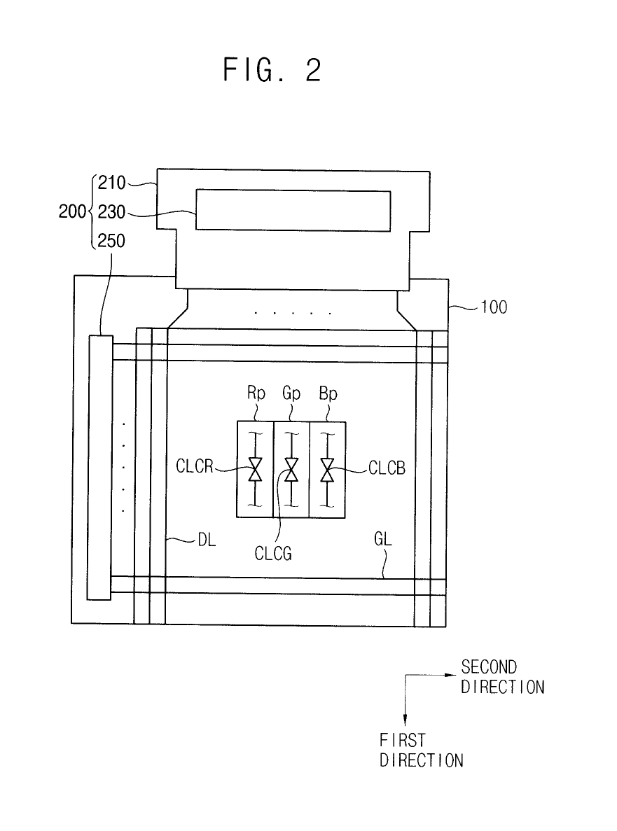

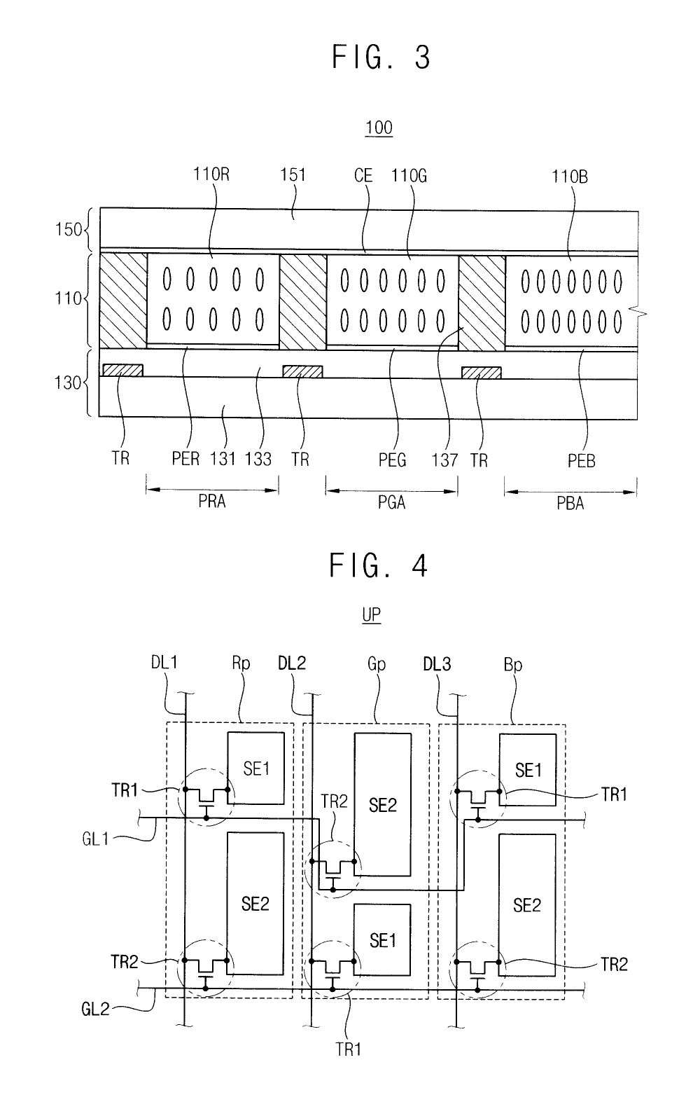

FIG. 2 is a block diagram illustrating an exemplary embodiment of a display apparatus according to the present invention. FIG. 3 is a cross-sectional view illustrating a portion of an exemplary embodiment of a display panel of FIG. 2.

Referring to FIG. 2, the display apparatus includes a display panel 100, and a panel driver 200 driving the display panel 100.

The display panel 100 includes a unit pixel UP, each unit pixel UP including a plurality of color pixels. For example, in the present exemplary embodiment the unit pixel UP includes a red pixel Rp, a green pixel Gp and a blue pixel Bp. The red pixel Rp includes a red cholesteric capacitor CLCR, the green pixel Gp includes a green cholesteric capacitor CLCG, and the blue pixel Bp includes a blue cholesteric capacitor CLCB. Hereinafter, the display panel 100 is explained referring to FIG. 3.

The display panel 100 includes a cholesteric liquid crystal layer 110, a display substrate 130 and an opposite substrate 150. The cholesteric liquid crystal layer 110 includes a plurality of color cholesteric liquid crystal layers 110R, 110G and 110B having different liquid crystal pitches from each other, i.e., the angle of characteristic cholesteric liquid crystal twisting is different for each color of cholesteric liquid crystal layer.

A first color cholesteric liquid crystal layer 110R is disposed in a first color pixel area PRA separated by a partition wall 137 from the other color pixel areas, and includes liquid crystals arranged having a first pitch. A second color cholesteric liquid crystal layer 110G is disposed in a second color pixel area PGA separated from the first color pixel area PRA by the partition wall 137, and includes liquid crystals arranged having a second pitch smaller than the first pitch. A third color cholesteric liquid crystal layer 110B is disposed in a third color pixel area PBA separated from the second color pixel area PGA by the partition wall 137, and includes liquid crystals arranged having a third pitch smaller than the second pitch.

A pitch of the cholesteric liquid crystal may be adjusted according to a quantity of chiral dopant in each cholesteric liquid crystal layer. Various colors may be displayed in a planar alignment according to the pitch of the cholesteric liquid crystal. For example, cholesteric liquid crystal having the first pitch displays red, e.g., reflects a red colored light, when in a planar alignment, cholesteric liquid crystal having the second pitch displays green, e.g., reflects a green colored light, when in a planar alignment, and cholesteric liquid crystal having the third pitch displays blue, e.g., reflects a blue colored light, when in a planar alignment.

A driving voltage V of the cholesteric liquid crystal is determined by Equation 1 as follows.

$$V ∝ \frac{d}{P \sqrt{Δɛ}} \qquad 〈 Equation 1 〉$$

Herein, P is a pitch of the liquid crystal layer, d is a cell gap of the liquid crystal layer, and ∈ is a dielectric constant. The driving voltage V of the cholesteric liquid crystal decreases as the pitch P increases, and increases as the cell gap d increases.

Accordingly, the red, green and blue cholesteric liquid crystal layers 110R, 110G and 110B have the cell gaps d and dielectric constant ∈ which are substantially the same as each other and the pitches P different from each other, so that the red, green and blue cholesteric liquid crystal layers 110R, 110G and 110B have different driving voltages V from each other. The first color cholesteric liquid crystal layer 110R has a first driving voltage VR, the second color cholesteric liquid crystal layer 110G has a second driving voltage VG greater than the first driving voltage VR, and the third color cholesteric liquid crystal layer 110B has a third driving voltage VB greater than the second driving voltage VG.

Referring to FIGS. 2 and 3, the display substrate 130 includes a first substrate 131, a plurality of data lines DL, a plurality of gate lines GL, a plurality of transistors TR, an insulating layer 133, a plurality of pixel electrodes PER, PEG and PEB, and a partition wall 137. The data lines DL are extended in a first direction. The gate lines GL are extended in the second direction. The transistors TR are connected to the data lines DL and the gate lines GL. The insulating layer 133 is disposed on the first substrate 131 on which the transistors TR are disposed. The pixel electrodes PER, PEG and PEB are disposed on the insulating layer within pixel areas and are connected to the transistors TR. The partition wall 137 is disposed between the pixel areas adjacent to each other to spatially separate the pixel areas from one another.

The opposite substrate 150 includes a second substrate 151 and a common electrode CE. The common electrode CE is disposed on the second substrate 151.

Accordingly, the red cholesteric capacitor CLCR includes a first pixel electrode PER, a red cholesteric liquid crystal layer 110R and the common electrode CE; the green cholesteric capacitor CLCG includes a second pixel electrode PEG a green cholesteric liquid crystal layer 110G and the common electrode CE; and the blue cholesteric capacitor CLCB includes a third pixel electrode PER, a blue cholesteric liquid crystal layer 110B and the common electrode CE.

In the red cholesteric capacitor CLCR, when an electric potential difference between the first pixel electrode PER and the common electrode CE is at a maximum, the red cholesteric liquid crystal layer 110R becomes a homeotropic alignment to display black, e.g., no light is reflected as perceived by a viewer. When the electric potential difference between the first pixel electrode PER and the common electrode CE is changed to be at a minimum in the homeotropic alignment, the red cholesteric liquid crystal layer 110R becomes a planar alignment to display red, e.g., to reflect a red colored light. In the same way, in the green cholesteric capacitor CLCG, when an electric potential difference between the second pixel electrode PEG and the common electrode CE is at a maximum, the green cholesteric liquid crystal layer 110G becomes a homeotropic alignment to display black, e.g., no light is reflected as perceived by a viewer. When the electric potential difference between the second pixel electrode PEG and the common electrode CE is changed to be at a minimum in the homeotropic alignment, the green cholesteric liquid crystal layer 110G becomes a planar alignment to display green, e.g., to reflect a green colored light. In the blue cholesteric capacitor CLCB, when an electric potential difference between the third pixel electrode PEB and the common electrode CE is at a maximum, the blue cholesteric liquid crystal layer 110B becomes a homeotropic alignment to display black, e.g., no light is reflected as perceived by a viewer. When the electric potential difference between the third pixel electrode PEB and the common electrode CE is changed to be at a minimum in a homeotropic alignment, the blue cholesteric liquid crystal layer 110B becomes a planar alignment to display blue, e.g., to reflect a green colored light.

In the present exemplary embodiment, the panel driver 200 includes a flexible circuit board 210, a main driving circuit 230 and a gate driving circuit 250.

Exemplary embodiments include configurations wherein the main driving circuit 230 may be mounted on the flexible circuit board 210. The main driving circuit 230 outputs data voltages to the data lines DL and controls a driving timing of the gate driving circuit 250. The gate driving circuit 250 outputs gate signals to the gate lines GL according to a control of the main driving circuit 230.

In the present exemplary embodiment, the main driving circuit 230 outputs positive data voltages with respect to a reference voltage Vo during an N-th frame and negative data voltages with respect to the reference voltage Vo during an (N+1)-th frame. Herein, N is a natural number. The reference voltage Vo is substantially the same as a voltage applied to the common electrode CE and a data voltage to drive the red, green and blue cholesteric capacitors CLCR, CLCG and CLCB in a planar alignment. Alternative exemplary embodiments include configurations wherein the data voltages are not polarity inversed as discussed above.

As a result, in one exemplary embodiment, the main driving circuit 230 outputs the data voltages having 7 levels. For example, the data voltages having 7 levels include the reference voltage Vo, a first red voltage +VR having a positive polarity, a second red voltage −VR having a negative polarity, a first green voltage +VG having a positive polarity, a second green voltage −VG having a negative polarity, a first blue voltage +VB having a positive polarity and a second blue voltage −VB having a negative polarity. Each of the first and second red voltages ±VR represents the data voltage to display the red pixel Rp as black, and has a first level difference with respect to the reference voltage Vo. Each of the first and second green voltages ±VG represents the data voltage to display the green pixel Gp as black, and has a second level difference with respect to the reference voltage Vo. Each of the first and second blue voltages ±VB represents the data voltages to display the blue pixel Bp as black, and has a third level difference with respect to the reference voltage Vo. The reference voltage Vo represents the data voltage to display colors to the red, green and blue pixels Rp, Gp and Bp.

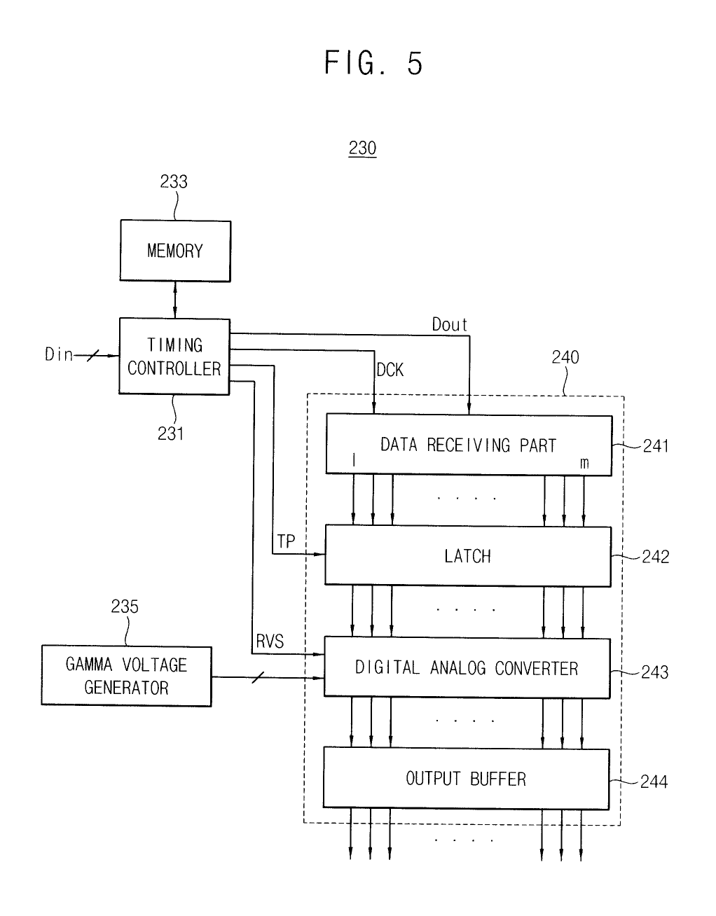

FIG. 4 is an equivalent circuit diagram illustrating the exemplary embodiment of a display panel of FIG. 2.

Referring to FIGS. 2 and 4, the unit pixel UP of the display panel 100 includes the red pixel Rp, the green pixel Gp and the blue pixel Bp.

The red pixel Rp includes a first sub-electrode SE1 disposed in a first sub-area and a second sub-electrode SE2 disposed in a second sub-area, which in the present exemplary embodiment is larger than the first sub-area. The first sub-electrode SE1 is electrically connected to a first transistor TR1 connected to a first data line DL1 and a first gate line GL1. The second sub-electrode SE2 is electrically connected to a second transistor TR2 connected to the first data line DL1 and a second gate line GL2.

The green pixel Gp includes a first sub-electrode SE1 disposed in a first sub-area and a second sub-electrode SE2 disposed in a second sub-area, which in the present exemplary embodiment is larger than the first sub-area. In the present exemplary embodiment, the first sub-electrode SE1 of the green pixel Gp is disposed adjacent to the second sub-electrode SE2 of the red pixel Rp, and the second sub-electrode SE2 of the green pixel Gp is disposed adjacent to the first sub-electrode SE1 of the red pixel Rp, although alternative exemplary embodiments include alternative configurations. The first sub-electrode SE1 is electrically connected to a first transistor TR1 connected to a second data line DL2 and the second gate line GL2. The second sub-electrode SE2 is electrically connected to a second transistor TR2 connected to the second data line DL2 and the first gate line GL1.

The blue pixel Bp includes a first sub-electrode SE1 disposed in a first sub-area and a second sub-electrode SE2 disposed in a second sub-area, which in the present exemplary embodiment is larger than the first sub-area. In the present exemplary embodiment, the first sub-electrode SE1 of the blue pixel Bp is disposed adjacent to the second sub-electrode SE2 of the green pixel Gp, and the second sub-electrode SE2 of the blue pixel Bp is disposed adjacent to the first sub-electrode SE1 of the green pixel Gp, although alternative exemplary embodiments include alternative configurations. The first sub-electrode SE1 is electrically connected to a first transistor TR1 connected to a third data line DL3 and the first gate line GL1. The second sub-electrode SE2 is electrically connected to a second transistor TR2 connected to the third data line DL3 and the second gate line GL2.

The unit pixel UP is spatially divided in order to display a grayscale. In the present exemplary embodiment, each of the red, green and blue pixels Rp, Gp and Bp is driven in four grayscales according to the data voltage applied to the first and second sub-electrodes SE1 and SE2. In a first grayscale, a high level data voltage VR, VG or VB is applied to both of the first and second sub-electrodes SE1 and SE2 of a single colored pixel. In a second grayscale, a low level data voltage Vo is applied to the first sub-electrode SE1, and the high level data voltage VR, VG or VB is applied to the second sub-electrode SE2 of a single colored pixel. In a third grayscale, the high level data voltage VR, VG or VB is applied to the first sub-electrode SE1, and the low level data voltage Vo is applied to the second sub-electrode SE2 of a single colored pixel. In a fourth grayscale, the low level data voltage Vo is applied to both of the first and second sub-electrodes SE1 and SE2 of a single colored pixel. As a result, the unit pixel UP, including all three single colored pixels Rp, Gp and Bp, may display 64 colors using the red, green and blue pixels Rp, Gp and Bp.

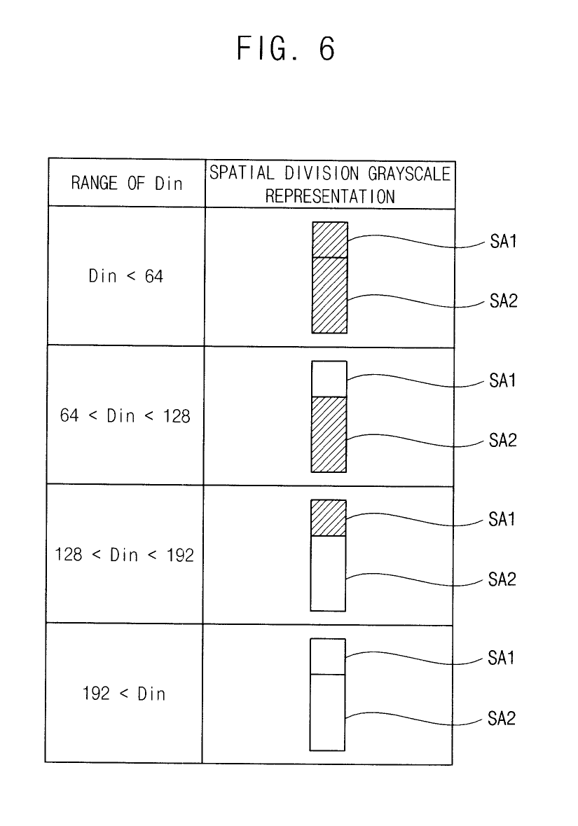

FIG. 5 is a block diagram illustrating an exemplary embodiment of the main driving circuit of FIG. 2. FIG. 6 is a conceptual diagram illustrating an exemplary embodiment of a spatial division grayscale algorithm according to a timing controller of FIG. 5.

Referring to FIGS. 4 and 5, the present exemplary embodiment of a main driving circuit 230 includes the timing controller 231, a memory 233, a gamma voltage generator 235 and a data driver 240.

The timing controller 231 receives a plurality of color data Din in parallel from outside. For example, the color data “Din” includes red data, green data and blue data. In the present exemplary embodiment each of the red, green and blue data are 8-bit data.

The timing controller 231 stores the received red, green and blue data Din in the memory 233, and generates first red sub-data, second red sub-data, first green sub-data, second green sub-data, first blue sub-data and second blue sub-data “Dout” which are rearranged using the spatial division grayscale algorithm from the stored red, green and blue data Din.

Referring to FIGS. 4 and 6, the timing controller 231 generates the first red sub-data and the second red sub-data to display black to an entire area SA1 and SA2 of the red pixel Rp, when a grayscale of the received 8-bit red data Din is less than 64 grayscales. Each of the first and second red sub-data may be 3-bit data corresponding to the first driving voltage VR. As explained above, taken together the driving voltages to drive the red, green and blue cholesteric liquid crystal layers 110R, 110G and 110B have 7 levels so that each of the first and second red sub-data may be at least 3-bit data.

The timing controller 231 generates the first red sub-data to display red in a first sub-area SA1, which in the present exemplary embodiment is smaller than a second sub-area SA2, and generates the second red sub-data to display black in the second sub-area SA2, when the grayscale of the received 8-bit red data Din is equal to or greater than a 64 grayscale and less than a 128 grayscale value. The first red sub-data may be 3-bit data corresponding to the reference voltage Vo, and the second red sub-data may be 3-bit data corresponding to the first driving voltage VR.

The timing controller 231 generates the first red sub-data to display black in the first sub-area SA1 and generates the second red sub-data to display red in the second sub-area SA2, when the grayscale of the received 8-bit red data Din is equal to or greater than a 128 grayscale and less than a 192 grayscale value. The first red sub-data may be 3-bit data corresponding to the first driving voltage VR, and the second red sub-data may be 3-bit data corresponding to the reference voltage Vo.

The timing controller 231 generates the first red sub-data and the second red sub-data to display red to the entire area SA1 and SA2 of the red pixel Rp, when the grayscale of the received 8-bit red data Din is equal to or greater than a 192 grayscale value. Each of the first and second red sub-data may be 3-bit data corresponding to the reference voltage Vo.

The timing controller 231 generates the first and second green sub-data from the received 8-bit green data, and generates the first and second blue sub-data from the received 8-bit blue data in a manner similar to the spatial division grayscale algorithm applied to the received red data described in detail above.

The gamma voltage generator 235 generates gamma voltages having 7 levels which are applied to the display as the data voltages. The gamma voltages include the reference voltage Vo, the first red voltage +VR having a positive polarity, the second red voltage −VR having a negative polarity, the first green voltage +VG having a positive polarity, the second green voltage −VG having a negative polarity, the first blue voltage +VB having a positive polarity and the second blue voltage −VB having a negative polarity.

In the present exemplary embodiment, the data driver 240 includes a data receiving part 241, a latch 242, a digital-analog converter 243 and an output buffer 244.

The data receiving part 241 sequentially receives m color sub-data which are 3-bit data and are outputted from the timing controller 231 in response to a data clock DCK provided from the timing controller 231, wherein, m is a natural number.

The latch 242 latches the m color sub-data, and outputs the latched m color sub-data in response to a load signal TP.

The digital-analog converter 243 converts the m color sub-data provided from the latch 242 into the data voltages using the gamma voltages. The digital-analog converter 243 controls a polarity of the data voltages based on an inverting signal RVS. In one exemplary embodiment, the polarity of the data voltages is inverted in a frame by frame manner; although alternative exemplary embodiments include configurations wherein the frame inversion is omitted.

The output buffer 244 buffers the m data voltages, and outputs the m data voltages to the m data lines.

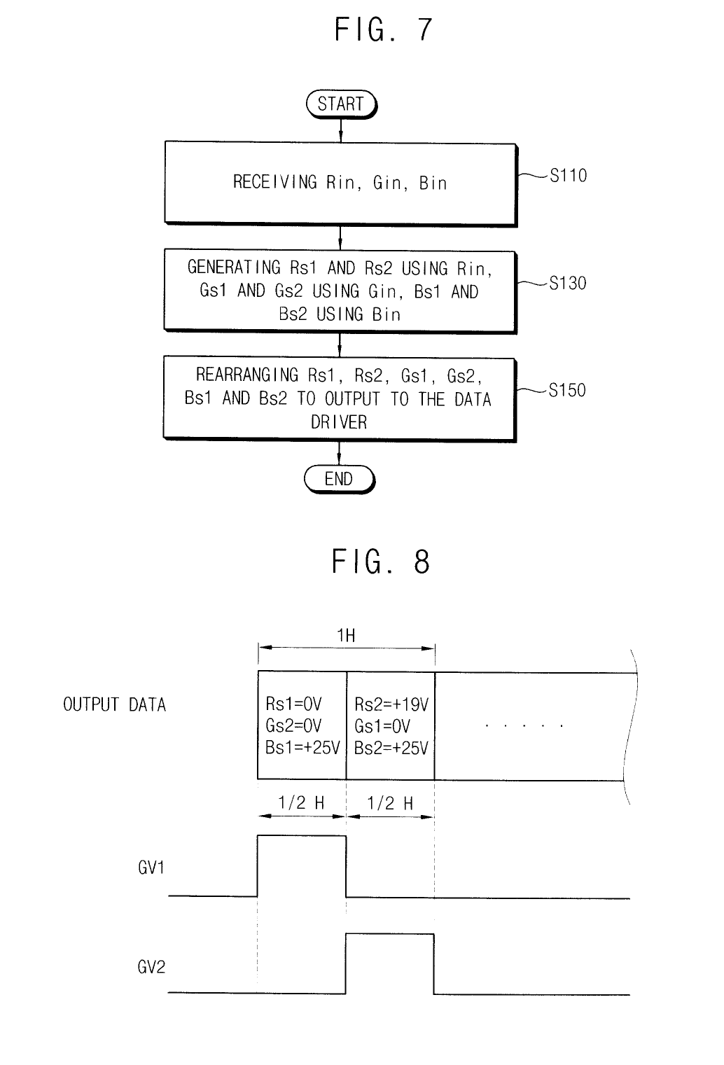

FIG. 7 is a flow chart illustrating a method of driving the main driving circuit of FIG. 5.

Referring to FIGS. 5 and 7, the timing controller 231 receives the red, green and blue data Rin, Gin and Bin (step S110). For example, in one exemplary embodiment each of the red, green and blue data are 8-bit data. In the present exemplary embodiment, a grayscale of the red data Rin is 120, a grayscale of the green data Gin is 200, and a grayscale of the blue data Bin is 30.

The timing controller 231 stores the red, green and blue data Rin, Gin and Bin received in parallel to the memory 233 while driving the main clock three times faster than a display having a finer grayscale control. The timing controller 231 generates the first red sub-data Rs1, the second red sub-data Rs2, the first green sub-data Gs1, the second green sub-data Gs2, the first blue sub-data Bs1 and the second blue sub-data Bs2 using the spatial division grayscale algorithm from the stored red, green and blue data Rin, Gin and Bin (step S130).

TABLE 1

| Dout (3 bits) | Driving Voltage |
|---|---|
| 000 | — |
| 001 | +VB (+25 V) |
| 010 | +VG (+22 V) |
| 011 | +VR (+19 V) |
| 100 | Vo (0 V) |
| 101 | −VR (−19 V) |
| 110 | −VG (−22 V) |
| 111 | −VB (−25 V) |

Referring to FIG. 6 and TABLE 1, the timing controller 231 generates the first red sub-data Rs1 to display red in the first sub-area SA1 and generates the second red sub-data Rs2 to display black in the second sub-area SA2, according to the 120 grayscale of the red data Rin. The timing controller 231 generates “100” (0V) as the first red sub-data Rs1 and “011” (+19V) as the second red sub-data Rs2.

In a similar manner, the timing controller 231 generates the first and second green sub-data Gs1 and Gs2 to display green in both of the first and second sub-areas SA1 and SA2 according to 200 grayscale of the green data Gin. The timing controller 231 generates “100” (0V) as the first green sub-data Gs1 and “100” (0V) as the second green sub-data Gs2.

The timing controller 231 generates the first and second blue sub-data Bs1 and Bs2 to display black in both of the first and second sub-areas SA1 and SA2 according to the 30 grayscale of the blue data Bin. The timing controller 231 generates “001” (+25V) as the first blue sub-data Bs1 and “001” (+25V) as the second blue sub-data Bs2.

The timing controller 231 rearranges the first red sub-data Rs1, the second red sub-data Rs2, the first green sub-data Gs1, the second green sub-data Gs2, the first blue sub-data Bs1 and the second blue sub-data Bs2, according to a pixel structure of the unit pixel, as shown in FIG. 4, to output to the data driver 240 (step S150).

FIG. 8 is a timing diagram illustrating an exemplary embodiment of a method of driving the display panel of FIG. 2.

Referring to FIGS. 4 and 8, the timing controller 231 provides “100,” which is the first red sub-data Rs1, “100,” which is the second green sub-data Gs2, and “001,” which is the first blue sub-data Bs1, to the data driver 240.

The data driver 240 converts the first red sub-data Rs1, the second green sub-data Gs2 and the first blue sub-data Bs1 to analog type data voltages “0V,” “0V” and “25V”, respectively, and outputs the analog type data voltages “0V,” “0V” and “25V” to the first, second and third data lines DL1, DL2 and DL3 during a first interval ½H of a horizontal period 1H, respectively. The gate driving circuit outputs a high level first gate signal GV1 to the first gate line GL1 synchronized with an output timing of the data voltages, “0V,” “0V” and “+25V” from the data driver 240.

Then, the data driver 240 converts the second red sub-data Rs2, the first green sub-data Gs1 and the second blue sub-data Bs2 to analog type data voltages “+19V,” “0V” and “25V” and outputs the analog type data voltages “+19V,” “0V” and “25V” to the first, second and third data lines DL1, DL2 and DL3 during a second interval ½H of a horizontal period 1H, respectively. The gate driving circuit outputs a high level second gate signal GV2 to the second gate line GL2 synchronized with an output timing of the data voltages, “+19V,” “0V” and “25V” from the data driver 240.

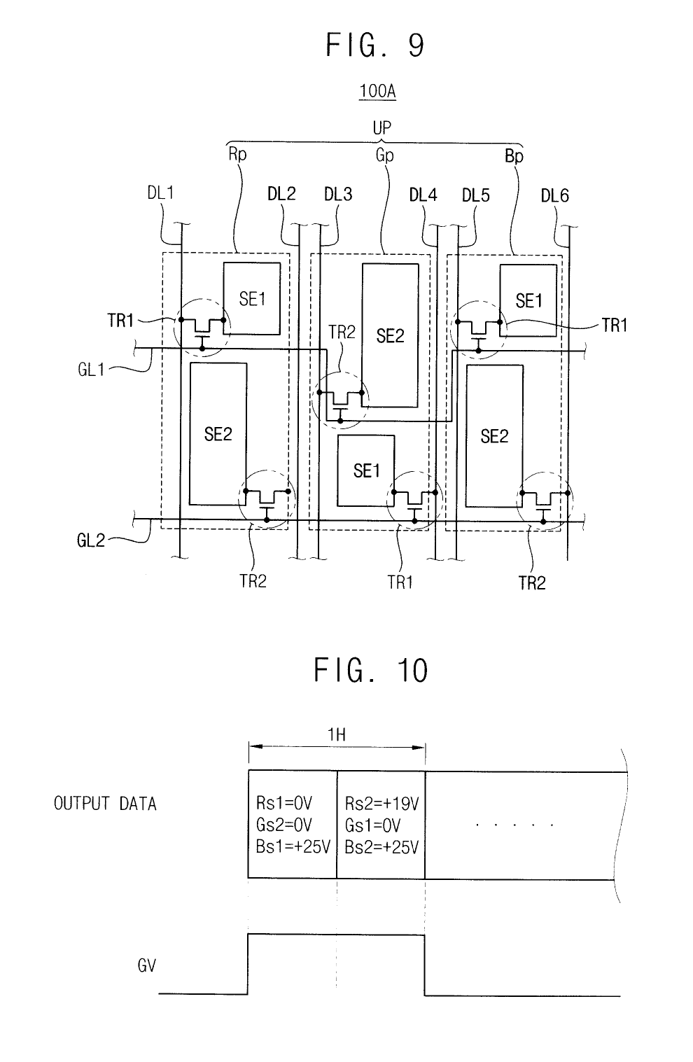

FIG. 9 is an equivalent circuit diagram illustrating another exemplary embodiment of a display panel according to the present invention.

Referring to FIG. 9, the unit pixel UP of the display panel 100A includes a red pixel Rp, a green pixel Gp and a blue pixel Bp.

The red pixel Rp includes a first sub-electrode SE1 disposed in a first sub-area and a second sub-electrode SE2 disposed in a second sub-area larger than the first sub-area. The first sub-electrode SE1 is electrically connected to a first transistor TR1 connected to a first data line DL1 and a gate line GL. The second sub-electrode SE2 is electrically connected to a second transistor TR2 connected to a second data line DL2 and the gate line GL.

The green pixel Gp includes a first sub-electrode SE1 disposed in a first sub-area and a second sub-electrode SE2 disposed in a second sub-area, which in the present exemplary embodiment is larger than the first sub-area. The first sub-electrode SE1 of the green pixel Gp is disposed adjacent to the second sub-electrode SE2 of the red pixel Rp, and the second sub-electrode SE2 of the green pixel Gp is disposed adjacent to the first sub-electrode SE1 of the red pixel Rp. The first sub-electrode SE1 is electrically connected to a first transistor TR1 connected to a fourth data line DL4 and the gate line GL. The second sub-electrode SE2 is electrically connected to a second transistor TR2 connected to a third data line DL3 and the gate line GL.

The blue pixel Bp includes a first sub-electrode SE1 disposed in a first sub-area and a second sub-electrode SE2 disposed in a second sub-area, which in the present exemplary embodiment is larger than the first sub-area. The first sub-electrode SE1 of the blue pixel Bp is disposed adjacent to the second sub-electrode SE2 of the green pixel Gp, and the second sub-electrode SE2 of the blue pixel Bp is disposed adjacent to the first sub-electrode SE1 of the green pixel Gp. The first sub-electrode SE1 is electrically connected to a first transistor TR1 connected to a fifth data line DL5 and the gate line GL. The second sub-electrode SE2 is electrically connected to a second transistor TR2 connected to the sixth data line DL6 and the gate line GL.

The unit pixel UP is spatially divided to display a grayscale. Each of the red, green and blue pixels Rp, Gp and Bp is driven in four grayscales according to a data voltage applied to the first and second sub-electrodes SE1 and SE2. In a first configuration, a high level data voltage VR, VG or VB is applied to both of the first and second sub-electrodes SE1 and SE2. In a second configuration, a low level data voltage Vo is applied to the first sub-electrode SE1, and the high level data voltage VR, VG or VB is applied to the second sub-electrode SE2. In a third configuration, the high level data voltage VR, VG or VB is applied to the first sub-electrode SE1, and the low level data voltage Vo is applied to the second sub-electrode SE2. In a fourth configuration, the low level data voltage Vo is applied to both of the first and second sub-electrodes SE1 and SE2. As a result, the unit pixel UP may display 64 colors using the red, green and blue pixels Rp, Gp and Bp.

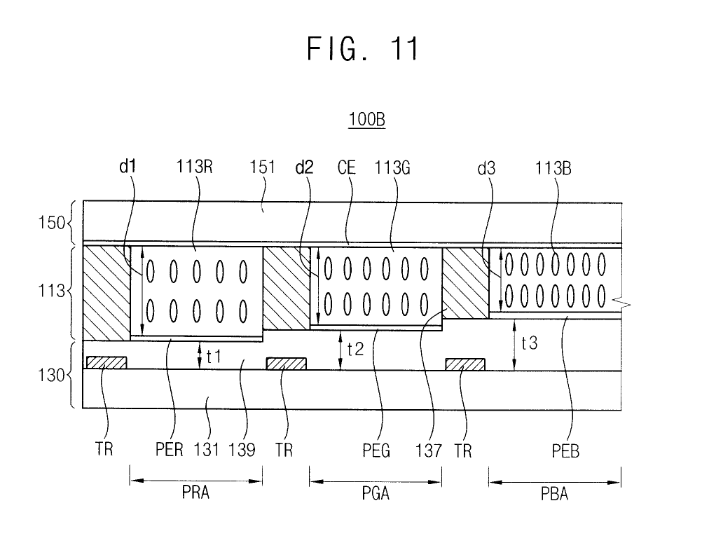

FIG. 10 is a timing diagram illustrating an exemplary embodiment of a method of driving the display panel of FIG. 9.

The timing controller 231 generates the first red sub-data Rs1, the second red sub-data Rs2, the first green sub-data Gs1, the second green sub-data Gs2, the first blue sub-data Bs1 and the second blue sub-data Bs2 using the spatial division grayscale algorithm as explained in the steps S110 to S130 referring to FIG. 7. The timing controller 231 rearranges the color sub-data according to a pixel structure of the unit pixel connected to the first to sixth data lines DL1, DL2, . . . , DL6.

The first red sub-data Rs1 is arranged corresponding to the first data line DL1, the second red sub-data Rs2 is arranged corresponding to the second data line DL2, the second green sub-data Gs2 is arranged corresponding to the third data line DL3, the first green sub-data Gs1 is arranged corresponding to the fourth data line DL4, the first blue sub-data Bs1 is arranged corresponding to the fifth data line DL5, and the second blue sub-data Bs2 is arranged corresponding to the sixth data line DL6.

For example, in the present exemplary embodiment the data driver 240 converts the first red sub-data Rs1, the second red sub-data Rs2, the first green sub-data Gs1, the second green sub-data Gs2, the first blue sub-data Bs1 and the second blue sub-data Bs2 into analog type data voltages and outputs the analog type data voltages to the first to sixth data lines DL1, DL2, . . . , DL6, respectively. The gate driving circuit outputs a high level gate signal GV to the gate line GL synchronized with an output timing of the data voltages from the data driver 240.

FIG. 11 is a cross-sectional view illustrating a portion of another exemplary embodiment of a display panel according to the present invention.

Referring to FIGS. 2 and 11, the display panel 100B includes a cholesteric liquid crystal layer 113, a display substrate 130 and an opposite substrate 150 as shown in FIG. 3.

The cholesteric liquid crystal layer 113 includes a plurality of color cholesteric liquid crystal layers 113R, 113G and 113B having pitches of the liquid crystal layer which are different from each other, respectively.

A red cholesteric liquid crystal layer 113R is disposed in a red pixel area PRA separated by a partition wall 137, has a first cell gap d1, and includes liquid crystals arranged having a first pitch. A green cholesteric liquid crystal layer 110G is disposed in a green pixel area PGA separated from the red pixel area PRA by the partition wall 137, has a second cell gap d2 thinner than the first cell gap d1, and includes liquid crystals arranged having a second pitch smaller than the first pitch. A blue cholesteric liquid crystal layer 110B is disposed in a blue pixel area PBA separated from the green pixel area PGA by the partition wall 137, has a third cell gap d3 thinner than the second cell gap d2, and includes liquid crystals arranged having a third pitch smaller than the second pitch.

According to Equation 1, the cell gaps d1, d2 and d3 of the red, green and blue cholesteric liquid crystal layers 113R, 113G and 113B are controlled to adjust driving voltages of the red, green and blue cholesteric liquid crystal layers 113R, 113G and 113B to be substantially equal to each other. According to the present example embodiment, the red, green and blue cholesteric liquid crystal layers 113R, 113G and 113B having the cell gaps different from each other may be arranged to be in a homeotropic alignment by substantially the same driving voltage VD.

The display substrate 130 includes a first substrate 131, a plurality of data lines DL, a plurality of gate lines GL, a plurality of transistors TR, an insulating layer 139, a plurality of pixel electrodes PER, PEG and PEB and a partition wall 137. The insulating layer 139 has a first thickness t1 corresponding to the red pixel area PRA, a second thickness t2 which is thicker than the first thickness t1 corresponding to the green pixel area PGA, and a third thickness t3 which is thicker than the second thickness t2 corresponding to the blue pixel area PBA. The cholesteric liquid crystal layer 113 may have various cell gaps due to the insulating layer 139 having the first, second and third thicknesses t1, t2 and t3.

The opposite substrate 150 includes a second substrate 151 and a common electrode CE. The common electrode CE is disposed on the second substrate 151.

The red, green and blue cholesteric liquid crystal layers 113R, 113G and 113B of the display panel 100B according to the present exemplary embodiment may be driven by substantially the same driving voltage, so that the data voltages have 3 levels (2 bits) as followed in TABLE 2.

TABLE 2

| Dout (2 bits) | Driving Voltage |
|---|---|
| 00 | — |
| 01 | +VD (+25 V) |
| 10 | Vo (0 V) |
| 11 | −VD (−25 V) |

A unit pixel of the display panel 100B may be connected to two gate lines GL1 and GL2 and three data lines DL1, DL2 and DL3 as shown in FIG. 4. In such an exemplary embodiment, a method of driving the display panel 100B may be substantially the same as the method of driving the display panel as shown in FIGS. 7 and 8.

In addition, in one exemplary embodiment the unit pixel of the display panel 100B may be connected to a gate line GL and six data lines DL1, DL2, . . . , DL6 as shown in FIG. 9. In this case, the method of driving the display panel 100B may be substantially the same as the method of driving the display panel as shown in FIGS. 7 and 10.

According to the present invention, the display panel including the first color pixel including the cholesteric liquid crystal having the first pitch, the second color pixel including the cholesteric liquid crystal having the second pitch and the third color pixel including the cholesteric liquid crystal having the third pitch is driven so that a color image may be displayed.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A method of driving a display panel, the display panel comprising a plurality of color pixels, each of the color pixels comprising a cholesteric liquid crystal layer, the method comprising:
generating a plurality of color sub-data from color data using a spatial division grayscale algorithm; and
converting the color sub-data into a data voltages to be provided to the color pixels.

2. The method of claim 1, wherein the data voltage comprises a reference voltage which drives the cholesteric liquid crystal layer to have a homeotropic alignment and a color voltage which drives the cholesteric liquid crystal layer to have a planar alignment.

3. The method of claim 2, wherein the data voltage is inverted with respect to the reference voltage in a frame by frame manner.

4. The method of claim 2, wherein the color pixel comprises a first sub-area and a second sub-area which is larger than the first sub-area.

5. The method of claim 4, wherein generating the color sub-data comprises:
generating first color sub-data and second color sub-data to display black in the first sub-area and the second sub-area of the color pixel when the color data are within a first grayscale range;
generating the first color sub-data and the second color sub-data to display a color in the first sub-area of the color pixel and to display black in the second sub-area of the color pixel when the color data are within a second grayscale range;
generating the first color sub-data and the second color sub-data to display black in the first sub-area of the color pixel and to display a color in the second sub-area of the color pixel when the color data are within a third grayscale range; and
generating the first color sub-data and the second color sub-data to display a color in the first sub-area and the second sub-area of the color pixel when the color data are within a fourth grayscale range,
wherein the first grayscale range, the second grayscale range, the third grayscale range and the fourth grayscale range are different.

6. The method of claim 5, wherein converting the color sub-data into the data voltage comprises:
converting the first color sub-data into a first data voltage to be provided to the color pixel during a first interval of a horizontal period; and
converting the second color sub-data into a second data voltage to be provided to the color pixel during a second interval of the horizontal period.

7. The method of claim 5, wherein converting the color sub-data into the data voltage comprises:
converting the first and second color sub-data into the data voltages to be provided to the color pixel at a same time during a horizontal period.

8. The method of claim 4, wherein the color pixels comprise a red pixel, a green pixel and a blue pixel,
a first sub-area of the green pixel is adjacent to a second sub-area of the red pixel and a second sub-area of the blue pixel, and
a second sub-area of the green pixel is adjacent to a first sub-area of the red pixel and a first sub-area of the blue pixel.

9. The method of claim 8, wherein the color voltage comprises a red color voltage, a green color voltage and a blue color voltage,
the red color voltage drives the cholesteric liquid crystal layer of the red pixel to have the planar alignment and has a first voltage level difference with respect to the reference voltage,
the green color voltage drives the cholesteric liquid crystal layer of the green pixel to have the planar alignment and has a second voltage level difference with respect to the reference voltage, and
the blue color voltage drives the cholesteric liquid crystal layer of the blue pixel to have the planar alignment and has a third voltage level difference with respect to the reference voltage.

10. A display apparatus comprising:
a display panel comprising a plurality of color pixels, each of the plurality of color pixels comprising a cholesteric liquid crystal layer; and
a panel driver which generates a plurality of color sub-data from color data using a spatial division grayscale algorithm and which converts the color sub-data into a data voltage to be provided to the color pixels.

11. The display apparatus of claim 10, wherein the display panel has a plurality of cell gaps which differ from each other according to colors of the color pixels.

12. The display apparatus of claim 10, wherein the panel driver generates a reference voltage which drives the cholesteric liquid crystal layer to have a homeotropic alignment and a color voltage which drives the cholesteric liquid crystal layer to have a planar alignment.

13. The display apparatus of claim 12, wherein the panel driver inverts the data voltage with respect to the reference voltage in a frame by frame manner to provide the inverted data voltage to the color pixels.

14. The display apparatus of claim 12, wherein the color pixel comprises a first sub-area and a second sub-area which is larger than the first sub-area, and
the panel driver generates:
first color sub-data and second color sub-data to display black in the first sub-area and the second sub-area of the color pixel when the color data are within a first grayscale range,
the first color sub-data and the second color sub-data to display a color in the first sub-area of the color pixel and to display the black in the second sub-area of the color pixel when the color data are within a second grayscale range,
the first color sub-data and the second color sub-data to display black in the first sub-area of the color pixel and to display a color in the second sub-area of the color pixel when the color data are within a third grayscale range, and
the first color sub-data and the second color sub-data to display a color in the first sub-area and the second sub-area of the color pixel when the color data are within a fourth grayscale range,
wherein the first grayscale range, the second grayscale range, the third grayscale range and the fourth grayscale range are different.

15. The display apparatus of claim 14, wherein the color pixel comprises a first sub-electrode and a second sub-electrode, the first sub-electrode is electrically connected to a data line and a first gate line and is disposed in the first sub-area, and the second sub-electrode is electrically connected to the data line and a second gate line and is disposed in the second sub-area.

16. The display apparatus of claim 15, wherein the panel driver outputs:
a first gate signal having a high voltage level to the first gate line and a first data voltage corresponding to the first color sub-data to the data line during a first interval of a horizontal period, and
a second gate signal having a high voltage level to the second gate line and a second data voltage corresponding to the second color sub-data to the data line during a second interval of the horizontal period,
wherein the high voltage level is sufficient to turn on a transistor connected to the data line

17. The display apparatus of claim 14, wherein the color pixel comprises a first sub-electrode and a second sub-electrode, the first sub-electrode is electrically connected to a first data line and a gate line and is disposed in the first sub-area, and the second sub-electrode is electrically connected to a second data line and the gate line and is disposed in the second sub-area.

18. The display apparatus of claim 17, wherein the panel driver outputs a gate signal having a high voltage level to the gate line and respectively outputs the data voltages corresponding to the first color sub-data and the second color sub-data to the first data line and the second data line, during a horizontal period.

19. The display apparatus of claim 14, wherein the color pixels comprise a red pixel, a green pixel and a blue pixel,
the first sub-area of the green pixel is adjacent to the second sub-area of the red pixel and the second sub-area of the blue pixel, and
the second sub-area of the green pixel is adjacent to the first sub-area of the red pixel and the blue pixel.

20. The display apparatus of claim 19, wherein the color voltage comprises a red color voltage, a green color voltage and a blue color voltage,
the red color voltage drives the cholesteric liquid crystal layer of the red pixel to have the planar alignment and has a first voltage level difference with respect to the reference voltage,
the green color voltage drives the cholesteric liquid crystal layer of the green pixel to have the planar alignment and has a second voltage level difference with respect to the reference voltage, and
the blue color voltage drives the cholesteric liquid crystal layer of the blue pixel to have the planar alignment and has a third voltage level difference with respect to the reference voltage.
